(19) United States
(12) Patent Application Publication
(10) Pub. No.: US 2019/0143889 A1
(43) Pub. Date: May 16, 2019

(54) Warning Light Assembly

(71) Applicant: Brendan Kelly, Livermore, CA (US)

(72) Inventor: Brendan Kelly, Livermore, CA (US)

(21) Appl. No.: 15/814,468

(22) Filed: Nov. 16, 2017

(51) Int. Cl. B60Q 1/52; G08G 1/0965; B65H 75/14; G01S 13/93; B60Q 5/00; B60Q 9/00; G08G 1/0967

(52) U.S. Cl. CPC B60Q 1/52; G08G 1/0965; B65H 75/143; F21Y 2115/10; B60Q 5/006; B60Q 9/008; G08G 1/096741; G01S 13/931

(57) ABSTRACT

A warning light assembly for alerting drivers to a hazard includes a housing that defines an internal space. At least one battery is coupled to the housing and is positioned in the internal space. A spool is rotationally coupled to the housing. A tube is loopedly positioned around the spool. The tube is flexible and substantially transparent. A plurality of lights is coupled to and is positioned within the tube. The lights are operationally coupled to the at least one battery. A block is coupled to a respective opposing end of the tube. The block is configured to anchor the respective opposing end of the tube to a surface, such as a road. The tube is configured to selectively extend from the housing to a deployed configuration. The lights are configured to illuminate to warn persons proximate to the tube, such as drivers, of a hazard.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to light assemblies and more particularly pertains to a new light assembly for alerting drivers to a hazard.

### BRIEF SUMMARY OF THE INVENTION

An embodiment of the disclosure meets the needs presented above by generally comprising a housing that defines an internal space. At least one battery is coupled to the housing and is positioned in the internal space. A spool is rotationally coupled to the housing. A tube is loopedly positioned around the spool. The tube is flexible and substantially transparent. A plurality of lights is coupled to and is positioned within the tube. The lights are operationally coupled to the at least one battery. A block is coupled to a respective opposing end of the tube. The block is configured to anchor the respective opposing end of the tube to a surface, such as a road. The tube is configured to selectively extend from the housing to a deployed configuration. The lights are configured to illuminate to warn persons proximate to the tube, such as drivers, of a hazard.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a warning light assembly according to an embodiment of the disclosure.

FIG. 2 is a back view of an embodiment of the disclosure.

FIG. 3 is a side view of an embodiment of the disclosure.

FIG. 4 is an in-use view of an embodiment of the disclosure.

FIG. 5 is an in-use view of an embodiment of the disclosure.

### DETAILED DESCRIPTION OF THE INVENTION

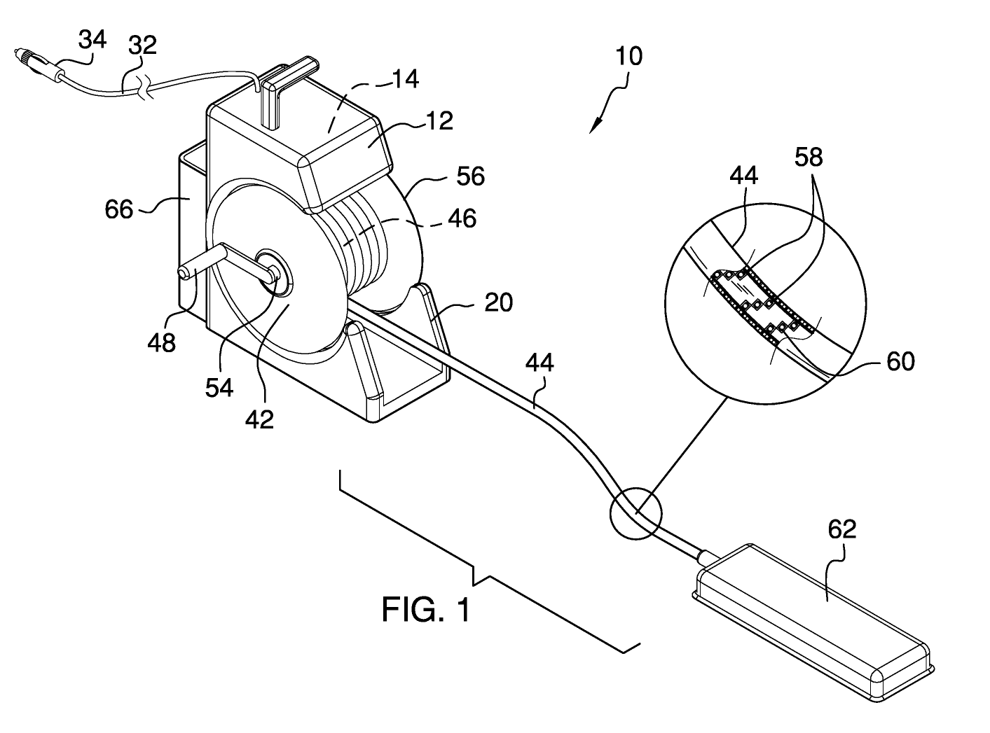

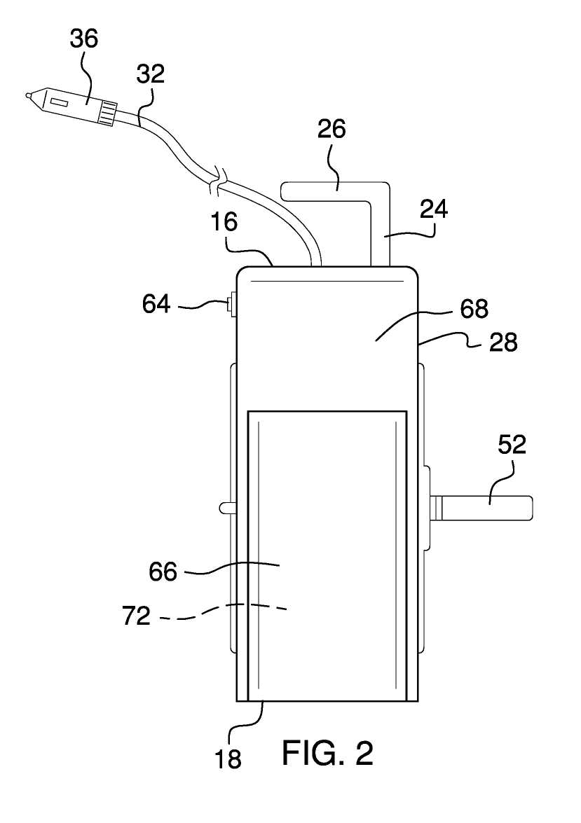

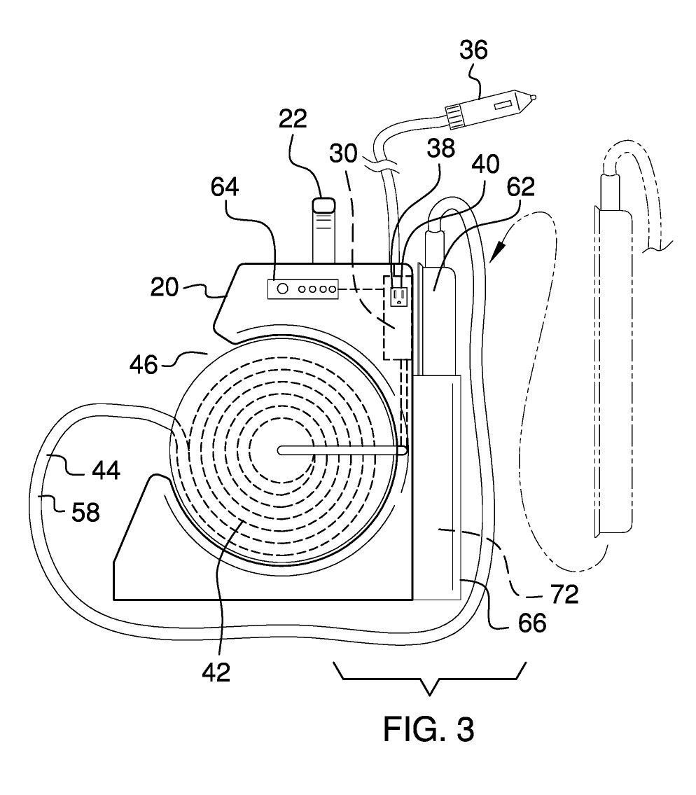

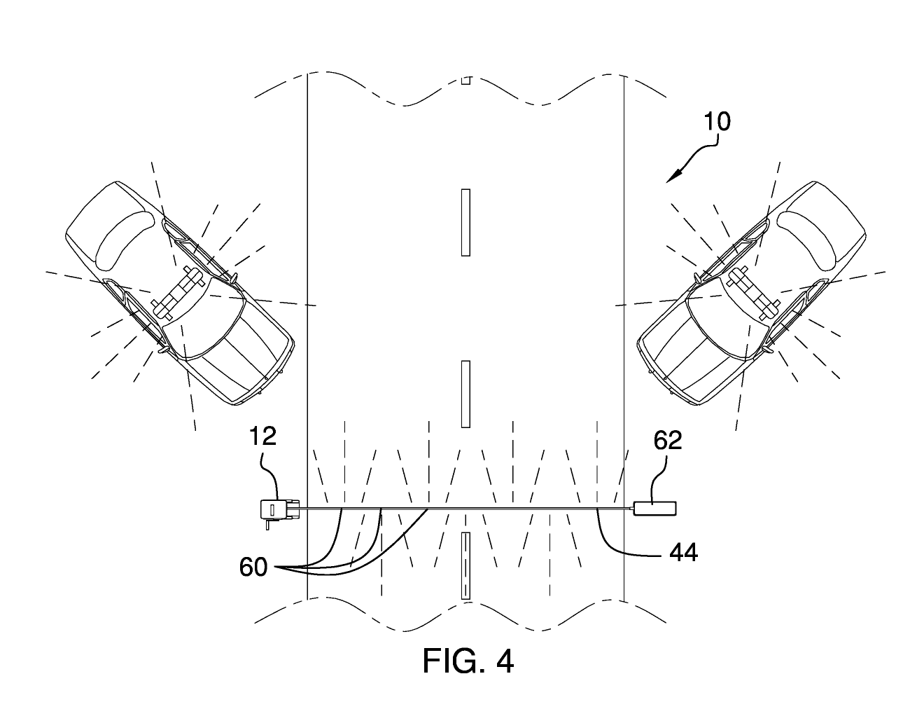

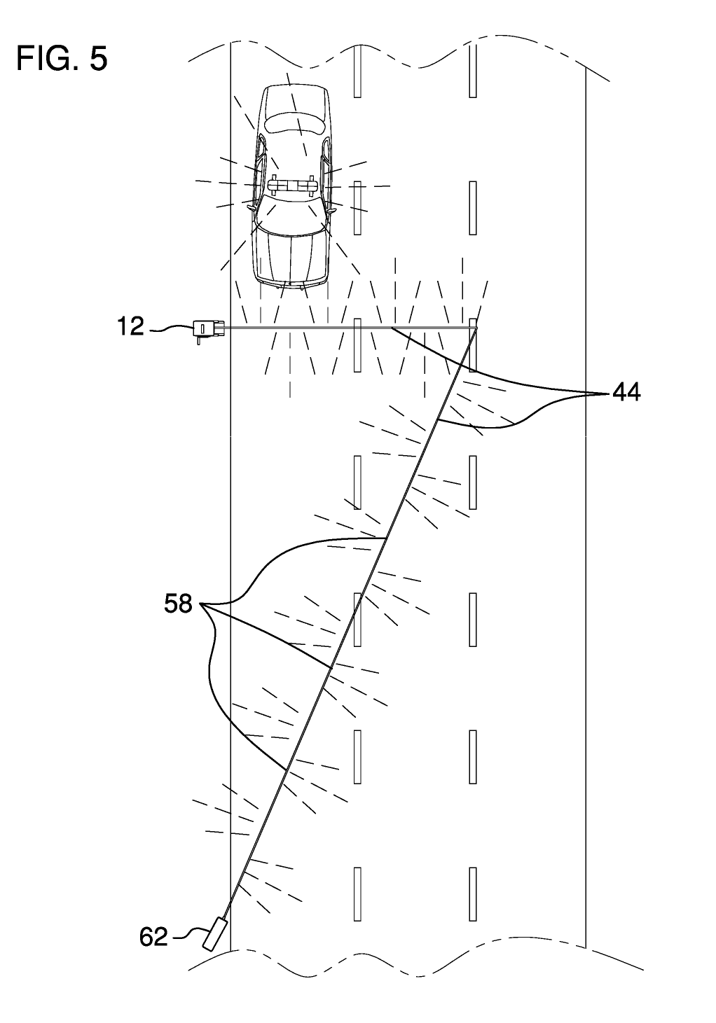

With reference now to the drawings, and in particular to FIGS. 1 through 5 thereof, a new light assembly embodying the principles and concepts of an embodiment of the disclosure and generally designated by the reference numeral 10 will be described.

As best illustrated in FIGS. 1 through 5, the warning light assembly 10 generally comprises a housing 12 that defines an internal space 14. In one embodiment, the housing 12 is substantially rectangularly box shaped. The housing 12 has a top 16 and a bottom 18. In another embodiment, the top 16 is dimensionally shorter than the bottom 18 such that a front 20 of the housing 12 is tapered.

A handle 22 is coupled to the top 16 of the housing 12. The handle 22 is configured to be grasped in a hand of a user to lift the housing 12. In one embodiment, the handle 22 comprises a first bar 24 and a second bar 26. The first bar 24 is coupled to and extends perpendicularly from the top 16. The first bar 24 is positioned proximate to a respective opposing side 28 of the housing 12. The second bar 26 is coupled to and extends perpendicularly from the first bar 24 distal from the housing 12. The second bar 26 is positioned to be grasped in the hand of the user to lift the housing 12.

At least one battery 30 is coupled to the housing 12 and is positioned in the internal space 14. In one embodiment, the at least one battery 30 is rechargeable. A cord 32 is coupled to and extends from the housing 12. The cord 32 is operationally coupled to the at least one battery 30. A connector 34 is coupled to the cord 32 distal from the housing 12. The connector 34 is configured to couple to a source of alternating current to recharge the at least one battery 30. In another embodiment, the connector 34 comprises a cigarette lighter plug 36.

A port 38 is coupled to the housing 12. The port 38 is positioned in a respective opposing side 28 of the housing 12. The port 38 is operationally coupled to the at least one battery 30. The port 38 is configured to couple to a power cable to supply power to a device of the user. In one embodiment, the port 38 comprises a Type B socket 40.

A spool 42 is rotationally coupled to the housing 12. A tube 44 is loopedly positioned around the spool 42. The tube 44 is configured to selectively extend from the housing 12. The tube 44 is flexible and substantially transparent.

A recess 46 is positioned in the front 20 of the housing 12. The recess 46 is complementary to the spool 42. The spool 42 is positioned within the recess 46.

A crank 48 is coupled to and extends from the spool 42. The crank 48 is configured to be grasped in the hand of the user to rotate the spool 42 to retract the tube 44 into the recess 46. In one embodiment, the crank 48 comprises a third bar 50 and a rod 52. The third bar 50 is coupled to an axle 54 of the spool 42. The third bar 50 extends parallelly with a hub 56 of the spool 42. The rod 52 is rotationally coupled to the third bar 50 distal from the axle 54. The rod 52 is positioned to be grasped in the hand of the user to rotate the spool 42 to retract the tube 44 into the recess 46.

A plurality of lights 58 is coupled to and is positioned within the tube 44. The lights 58 are operationally coupled to the at least one battery 30. In one embodiment, the plurality of lights 58 comprises light emitting diodes 60.

A block 62 is coupled to a respective opposing end 74 of the tube 44. The block 62 is configured to anchor the respective opposing end 74 of the tube 44 to a surface, such as a road. The tube 44 is configured to selectively extend from the housing 12 to a deployed configuration. The lights 58 are configured to illuminate to warn persons proximate to the tube 44, such as drivers, of a hazard. In one embodiment, the block 62 is substantially rectangularly box shaped.

A controller 64 is coupled to the housing 12. The controller 64 is operationally coupled to the at least one battery 30 and the plurality of lights 58. The controller 64 is positioned to selectively couple the lights 58 to the at least one battery 30. In one embodiment, the controller 64 is configured to intermittently couple the lights 58 to the at least one battery 30 so that the lights 58 are configured to flash.

A shell 66 is coupled to a back 68 of the housing 12. The shell 66 has an upper face 70. The upper face 70 is open so the shell 66 defines a cavity 72. The cavity 72 is complementary to the block 62. The cavity 72 is positioned to insert the block 62 to couple the block 62 to the housing 12 to stow the block 62.

In use, the block 62 is configured to anchor the respective opposing end 74 of the tube 44 to the surface, such as the road. The tube 44 is configured to selectively extend from the housing 12 to the deployed configuration. The controller 64 is positioned to selectively couple the lights 58 to the at least one battery 30. The lights 58 are configured to illuminate to warn the persons proximate to the tube 44, such as the drivers, of the hazard. The crank 48 is configured to be grasped in the hand of the user to rotate the spool 42 to retract the tube 44 into the recess 46. The cavity 72 is positioned to insert the block 62 to couple the block 62 to the housing 12 to stow the block 62. The connector 34 that is positioned on the cord 32 is configured to couple to a source of alternating current to recharge the at least one battery 30. The port 38 that is positioned in the housing 12 is configured to couple to the power cable to supply power to the device of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A warning light assembly comprising:
a housing defining an internal space;
at least one battery coupled to said housing and positioned in said internal space;
a spool rotationally coupled to said housing;
a tube loopedly positioned around said spool, said tube being flexible, said tube being substantially transparent;
a plurality of lights coupled to and positioned within said tube wherein said plurality of lights emits light outwardly through and around a full diameter of said tube such that said plurality of lights are configured to be seen from all directions around said tube, said lights being operationally coupled to said at least one battery;
a block coupled to a respective opposing end of said tube; and
wherein said tube is positioned on said spool such that said tube is configured for selectively extending from said housing, wherein said block is positioned on said respective opposing end of said tube and extendable with said respective opposing end of said tube away from said spool when said spool is rotated such that said block is configured for anchoring said respective said opposing end of said tube to a surface such that said tube is configured for selectively extending from said housing to a deployed configuration and said lights are configured for illuminating for warning persons proximate to said tube of a hazard.

2. The assembly of claim 1, further including said housing being substantially rectangularly box shaped, said housing having a top and a bottom, said top being dimensionally shorter than said bottom such that a front of said housing is tapered.

3. The assembly of claim 1, further including a handle coupled to a top of said housing, wherein said handle is positioned on said housing such that said handle is configured for grasping in a hand of a user for lifting said housing.

4. The assembly of claim 3, further including said handle comprising a first bar and a second bar, said first bar being coupled to and extending perpendicularly from said top, said first bar being positioned proximate to a respective opposing side of said housing, said second bar being coupled to and extending perpendicularly from said first bar distal from said housing such that said second bar is positioned for grasping in the hand of the user for lifting said housing.

5. The assembly of claim 1, further including said at least one battery being rechargeable.

6. The assembly of claim 5, further comprising:
a cord coupled to and extending from said housing, said cord being operationally coupled to said at least one battery;
a connector coupled to said cord distal from said housing; and
wherein said connector is positioned on said cord such that said connector is configured for coupling to a source of alternating current for recharging said at least one battery.

7. The assembly of claim 6, further including said connector comprising a cigarette lighter plug.

8. The assembly of claim 1, further including a port coupled to said housing, said port being positioned in a respective opposing side of said housing, said port being operationally coupled to said at least one battery, wherein said port is positioned in said housing such that said port is configured for coupling to a power cable for supplying power to a device of the user.

9. The assembly of claim 8, further including said port comprising a Type B socket.

10. The assembly of claim 1, further including a recess positioned in a front of said housing, said recess being complementary to said spool, said spool being positioned within said recess.

11. The assembly of claim 10, further including a crank coupled to and extending from said spool, wherein said crank is positioned on said spool such that said crank is configured for grasping in a hand of a user for rotating of said spool for retracting said tube into said recess.

12. The assembly of claim 11, further including said crank comprising a third bar and a rod, said third bar being coupled to an axle of said spool, said third bar extending parallelly with a hub of said spool, said rod being rotationally coupled to said third bar distal from said axle such that said rod is positioned for grasping in the hand of the user for rotating of said spool for retracting said tube into said recess.

13. The assembly of claim 1, further including said plurality of lights comprising light emitting diodes.

14. The assembly of claim 1, further including said block being substantially rectangularly box shaped.

15. The assembly of claim 1, further including a controller coupled to said housing, said controller being operationally coupled to said at least one battery and said plurality of lights, wherein said controller is positioned on said housing such that said controller is positioned for selectively coupling said lights to said at least one battery.

16. The assembly of claim 15, further including said controller being configured for intermittent coupling of said lights to said at least one battery such that said lights are configured for flashing.

17. The assembly of claim 1, further including a shell coupled to a back of said housing, said shell having an upper face, said upper face being open such the said shell defines a cavity, said cavity being complementary to said block, wherein said shell is positioned on said housing such that said cavity is positioned for inserting said block for coupling said block to said housing for stowing said block.

18. A warning light assembly comprising:
a housing defining an internal space, said housing being substantially rectangularly box shaped, said housing having a top and a bottom, said top being dimensionally shorter than said bottom such that a front of said housing is tapered;
a handle coupled to said top of said housing, wherein said handle is positioned on said housing such that said handle is configured for grasping in a hand of a user for lifting said housing, said handle comprising a first bar and a second bar, said first bar being coupled to and extending perpendicularly from said top, said first bar being positioned proximate to a respective opposing side of said housing, said second bar being coupled to and extending perpendicularly from said first bar distal from said housing such that said second bar is positioned for grasping in the hand of the user for lifting said housing;
at least one battery coupled to said housing and positioned in said internal space, said at least one battery being rechargeable;
a cord coupled to and extending from said housing, said cord being operationally coupled to said at least one battery;
a connector coupled to said cord distal from said housing, wherein said connector is positioned on said cord such that said connector is configured for coupling to a source of alternating current for recharging said at least one battery, said connector comprising a cigarette lighter plug;
a port coupled to said housing, said port being positioned in a respective opposing side of said housing, said port being operationally coupled to said at least one battery, wherein said port is positioned in said housing such that said port is configured for coupling to a power cable for supplying power to a device of the user, said port comprising a Type B socket;
a spool rotationally coupled to said housing;
a recess positioned in said front of said housing, said recess being complementary to said spool, said spool being positioned within said recess;
a tube loopedly positioned around said spool, wherein said tube is positioned on said spool such that said tube is configured for selectively extending from said housing, said tube being flexible, said tube being substantially transparent;
a crank coupled to and extending from said spool, wherein said crank is positioned on said spool such that said crank is configured for grasping in the hand of the user for rotating of said spool for retracting said tube into said recess, said crank comprising a third bar and a rod, said third bar being coupled to an axle of said spool, said third bar extending parallelly with a hub of said spool, said rod being rotationally coupled to said third bar distal from said axle such that said rod is positioned for grasping in the hand of the user for rotating of said spool for retracting said tube into said recess;
a plurality of lights coupled to and positioned within said tube wherein said plurality of lights emits light outwardly through and around a full diameter of said tube such that said plurality of lights are configured to be seen from all directions around said tube, said lights being operationally coupled to said at least one battery, said plurality of lights comprising light emitting diodes;
a block coupled to a respective opposing end of said tube, wherein said block is positioned on said respective opposing end of said tube and extendable with said respective opposing end of said tube away from said spool when said spool is rotated such that said block is configured for anchoring said respective said opposing end of said tube to a surface such that said tube is held in an extended position extended away from said housing to a deployed configuration and said lights are configured for illuminating for warning persons proximate to said tube of a hazard, said block being substantially rectangularly box shaped;
a controller coupled to said housing, said controller being operationally coupled to said at least one battery and said plurality of lights, wherein said controller is positioned on said housing such that said controller is positioned for selectively coupling said lights to said at least one battery, said controller being configured for intermittent coupling of said lights to said at least one battery such that said lights are configured for flashing;
a shell coupled to a back of said housing, said shell having an upper face, said upper face being open such the said shell defines a cavity, said cavity being complementary to said block, wherein said shell is positioned on said housing such that said cavity is positioned for inserting said block for coupling said block to said housing for stowing said block; and
wherein said block is positioned on said tube such that said block is configured for anchoring said respective said opposing end of said tube to the surface such that said tube is configured for selectively extending from said housing to the deployed configuration, wherein said controller is positioned on said housing such that said controller is positioned for selectively coupling said lights to said at least one battery such that said lights are configured for illuminating for warning the persons proximate to said tube of the hazard, wherein said crank is positioned on said spool such that said crank is configured for grasping in the hand of the user for rotating of said spool for retracting said tube into said recess, wherein said shell is positioned on said housing such that said cavity is positioned for inserting said block for coupling said block to said housing for stowing said block, wherein said connector is positioned on said cord such that said connector is configured for coupling to a source of alternating current for recharging said at least one battery, wherein said port is positioned in said housing such that said port is configured for coupling to the power cable for supplying power to the device of the user.
